(19) United States
(12) Patent Application Publication
(10) Pub. No.: US 2006/0157648 A1
(43) Pub. Date: Jul. 20, 2006

(54) Methods, compositions and devices for performing ionization desorption on silicon derivatives

(75) Inventors: Gary Siuzdak, San Diego, CA (US); Eden Go, San Diego, CA (US); Zhouxin Shen, San Diego, CA (US); Bruce Compton, Lexington, MA (US); Edouard S. P. Bouvier, Stow, MA (US); Grace Credo, Foster City, CA (US)

Correspondence Address: WATERS INVESTMENTS LIMITED;C/O WATERS CORPORATION, 34 MAPLE STREET - LG, MILFORD, MA, 01757, US

(73) Assignee: WATERS INVESTMENTS LIMITED, New Castle, DE (US)

(21) Appl. No.: 11/288,590

(22) Filed: Nov. 29, 2005

Related U.S. Application Data
(63) Continuation of application No. PCT/US04/17853, filed on Jun. 4, 2004.
(60) Provisional application No. 60/476,762, filed on Jun. 6, 2003.
(60) Provisional application No. 60/556,984, filed on Mar. 26, 2004.

(51) Int. Cl. H01J 49/00

(52) U.S. Cl. 250/288

(57) ABSTRACT

Embodiments of the present invention are directed to a substrate for performing ionization desorption on porous silicon, methods for performing such ionization desorption and methods of making substrates. One embodiment directed to a substrate for performing ionization desorption on silicon comprises a substrate having a surface having a formula of:

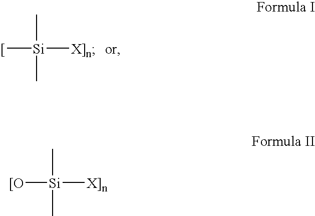

As used above, X is H or Y, where at least at least twenty five mole percent of X is Y and Y is hydroxyl, or —O—R₁ or O—SiR₁,R₂,R₃ wherein R₁,R₂, and R₃ are selected from the group consisting C₁ to C₆ straight, cyclic, or branched alkyl, aryl, or alkoxy group, a hydroxyl group, or a siloxane group, and R⁶ may be a C₁ to C₃₆ straight, cyclic, or branched alkyl (e.g., C_{18,} cyanopropyl), aryl, or alkoxy group, where the groups of R⁶ are unsubstituted or substituted with one or more moieties such as halogen, cyano, amino, diol, nitro, ether, carbonyl, epoxide, sulfonyl, cation exchanger, anion exchanger, carbamate, amide, urea, peptide, protein, carbohydrate, and nucleic acid functionalities. The letter “n” represents an integer from 1 to infinity and any vacant valences are silicon atoms, hydrogen or impurities.

### CROSS REFERENCE TO RELATED APPLICATIONS

This application claims benefit of and is a continuation of International Application No. PCT/US04/017853, filed Jun. 4, 2004, Attorney docket number AE-352 and designating the United States, which claims benefit of a priority to U.S. Provisional Application No. 60/476,762, filed Jun. 6, 2003, Attorney docket number WAA-352 and U.S. Provisional Application No. 60/556,984, filed Mar. 26, 2004, Attorney docket number AE-390, the content of which is expressly incorporated herein by reference in its entirety.

### STATEMENT ON FEDERALLY SPONSORED RESEARCH

N/A

### FIELD OF THE INVENTION

Embodiments of the present invention are directed to substrates of silicon used for performing ionization desorption. These substrates are used in laser equipped mass spectroscopy instruments. Substrates of the present invention provide consistent results after repeated use.

### BACKGROUND OF THE INVENTION

Substrates of porous silicon are used with laser equipped mass spectrometers to perform analyses of samples. The substrate is in the form of a chip having dimensions of approximately three to five centimeters and a thickness of 0.5 millimeter. Sample, generally in the form of an aqueous solution in which one or more compounds are dissolved, is received on the substrate. The substrate is placed in a holder in close proximity to the inlet of a mass spectrometer. A laser pulse is directed to the sample and a portion of the sample is ionized and vaporized from the surface of the substrate by the laser.

As used herein, the term “vaporized” means rendered into a gaseous state. The term “ionized means” having a positive or negative charge.

A further portion of the ionized sample is received by the mass analyzer, for example a time of flight (TOF) mass spectrometer. The mass spectrometer provides information as to the mass and charge of the ionized molecules that comprise the sample. This process, the equipment and the substrates are described in U.S. Pat. No. 6,288,390.

As used herein, the term “DIOS” refers to desorption ionization on silicon and the determination of mass and charge information of ions formed by laser ionization. Such mass and charge information is typically in the form of a mass to charge ratio.

Substrates of porous silicon have a silicon hydride surface. These silicon hydride surfaces oxidize over time. This change in the surface chemistry effects the ionization and vaporization process. Results from the mass spectrometer with the same substrate shift over time due to the change in the surface chemistry.

A more stable surface chemistry would provide greater sensitivity in DIOS processes. Embodiments of the present invention describe such chemistry with reference to the words and phrases below, which words and phrases are defined for purposes of clarity.

The term “aliphatic group” includes organic compounds characterized by straight or branched chains, typically having between 1 and 22 carbon atoms. Aliphatic groups include alkyl groups, alkenyl groups and alkynyl groups. In complex structures, the chains can be branched or cross-linked. Alkyl groups include saturated hydrocarbons having one or more carbon atoms, including straight-chain alkyl groups and branched-chain alkyl groups. Such hydrocarbon moieties may be substituted on one or more carbons with, for example, a halogen, a hydroxyl, a thiol, an amino, an alkoxy, an alkylcarboxy, an alkylthio, or a nitro group. Unless the number of carbons is otherwise specified, “lower aliphatic” as used herein means an aliphatic group, as defined above (e.g., lower alkyl, lower alkenyl, lower alkynyl), but having from one to six carbon atoms. Representative of such lower aliphatic groups, e.g., lower alkyl groups, are methyl, ethyl, n-propyl, isopropyl, 2-chloropropyl, n-butyl, sec-butyl, 2-aminobutyl, isobutyl, tert-butyl, 3-thiopentyl, and the like.

As used herein, the term “nitro” means —NO₂; the term “halogen” designates —F, —Cl, —Br or —I; the term “thiol” means SH; and the term “hydroxyl” means —OH.

The term “alicyclic group” includes closed ring structures of three or more carbon atoms. Alicyclic groups include cycloparaffins which are saturated cyclic hydrocarbons, cycloolefins and naphthalenes which are unsaturated with two or more double bonds, and cycloacetylenes which have a triple bond. They do not include aromatic groups. Examples of cycloparaffins include cyclopropane, cyclohexane, and cyclopentane. Examples of cycloolefins include cyclopentadiene and cyclooctatetraene. Alicyclic groups also include fused ring structures and substituted alicyclic groups such as alkyl substituted alicyclic groups. In the instance of the alicyclics such substituents can further comprise a lower alkyl, a lower alkenyl, a lower alkoxy, a lower alkylthio, a lower alkylamino, a lower alkylcarboxyl, a nitro, a hydroxyl, —CF₃, —CN, or the like.

The term “heterocyclic group” includes closed ring structures in which one or more of the atoms in the ring is an element other than carbon, for example, nitrogen, sulfur, or oxygen. Heterocyclic groups can be saturated or unsaturated and heterocyclic groups such as pyrrole and furan can have aromatic character. They include fused ring structures such as quinoline and isoquinoline. Other examples of heterocyclic groups include pyridine and purine. Heterocyclic groups can also be substituted at one or more constituent atoms with, for example, a halogen, a lower alkyl, a lower alkenyl, a lower alkoxy, a lower alkylthio, a lower alkylamino, a lower alkylcarboxyl, a nitro, a hydroxyl, —CF₃, —CN, or the like. Suitable heteroaromatic and heteroalicyclic groups generally will have 1 to 3 separate or fused rings with 3 to about 8 members per ring and one or more N, O or S atoms, e.g. coumarinyl, quinolinyl, pyridyl, pyrazinyl, pyrimidyl, furyl, pyrrolyl, thienyl, thiazolyl, oxazolyl, imidazolyl, indolyl, benzofuranyl, benzothiazolyl, tetrahydrofuranyl, tetrahydropyranyl, piperidinyl, morpholino and pyrrolidinyl.

The term “aromatic group” includes unsaturated cyclic hydrocarbons containing one or more rings. Aromatic groups include 5- and 6-membered single-ring groups which may include from zero to four heteroatoms, for example, benzene, pyrrole, furan, thiophene, imidazole, oxazole, thiazole, triazole, pyrazole, pyridine, pyrazine, pyridazine and pyrimidine, and the like. The aromatic ring may be substituted at one or more ring positions with, for example, a halogen, a lower alkyl, a lower alkenyl, a lower alkoxy, a lower alkylthio, a lower alkylamino, a lower alkylcarboxyl, a nitro, a hydroxyl, —CF₃, —CN, or the like.

The term “alkyl” includes saturated aliphatic groups, including straight-chain alkyl groups, branched-chain alkyl groups, cycloalkyl (alicyclic) groups, alkyl substituted cycloalkyl groups, and cycloalkyl substituted alkyl groups. In preferred embodiments, a straight chain or branched chain alkyl has 20 or fewer carbon atoms in its backbone (e.g., C₁-C₂₀ for straight chain, C₃-C₂₀ for branched chain), and more preferably 12 or fewer. Likewise, preferred cycloalkyls have from 4-10 carbon atoms in their ring structure, and more preferably have 4-7 carbon atoms in the ring structure. The term “lower alkyl” refers to alkyl groups having from 1 to 6 carbons in the chain, and to cycloalkyls having from 3 to 6 carbons in the ring structure.

Moreover, the term “alkyl” (including “lower alkyl”) as used throughout the specification and claims includes both “unsubstituted alkyls” and “substituted alkyls”, the latter of which refers to alkyl moieties having substituents replacing a hydrogen on one or more carbons of the hydrocarbon backbone. Such substituents can include, for example, halogen, hydroxyl, alkylcarbonyloxy, arylcarbonyloxy, alkoxycarbonyloxy, aryloxycarbonyloxy, carboxylate, alkylcarbonyl, alkoxycarbonyl, aminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), amidino, imino, sulfhydryl, alkylthio, arylthio, thiocarboxylate, sulfate, sulfonato, sulfamoyl, sulfonamido, nitro, trifluoromethyl, cyano, azido, heterocyclyl, aralkyl, or an aromatic or heteroaromatic moiety. It will be understood by those skilled in the art that the moieties substituted on the hydrocarbon chain can themselves be substituted, if appropriate. Cycloalkyls can be further substituted, e.g., with the substituents described above. An “aralkyl” moiety is an alkyl substituted with an aryl, e.g., having 1 to 3 separate or fused rings and from 6 to about 18 carbon ring atoms, (e.g., phenylmethyl (benzyl)).

The term “alkylamino” as used herein means an alkyl group, as defined herein, having an amino group attached thereto. Suitable alkylamino groups include groups having 1 to about 12 carbon atoms, preferably from 1 to about 6 carbon atoms. The term “alkylthio” refers to an alkyl group, as defined above, having a sulfhydryl group attached thereto. Suitable alkylthio groups include groups having 1 to about 12 carbon atoms, preferably from 1 to about 6 carbon atoms. The term “alkylcarboxyl” as used herein means an alkyl group, as defined above, having a carboxyl group attached thereto. The term “alkoxy” as used herein means an alkyl group, as defined above, having an oxygen atom attached thereto. Representative alkoxy groups include groups having 1 to about 12 carbon atoms, preferably 1 to about 6 carbon atoms, e.g., methoxy, ethoxy, propoxy, tert-butoxy and the like. The terms “alkenyl” and “alkynyl” refer to unsaturated aliphatic groups analogous to alkyls, but which contain at least one double or triple bond respectively. Suitable alkenyl and alkynyl groups include groups having 2 to about 12 carbon atoms, preferably from 1 to about 6 carbon atoms.

The term “aryl” includes 5- and 6-membered single-ring aromatic groups that may include from zero to four heteroatoms, for example, unsubstituted or substituted benzene, pyrrole, furan, thiophene, imidazole, oxazole, thiazole, triazole, pyrazole, pyridine, pyrazine, pyridazine and pyrimidine, and the like. Aryl groups also include polycyclic fused aromatic groups such as naphthyl, quinolyl, indolyl, and the like. The aromatic ring can be substituted at one or more ring positions with such substituents, e.g., as described above for alkyl groups. Suitable aryl groups include unsubstituted and substituted phenyl groups. The term “aryloxy” as used herein means an aryl group, as defined above, having an oxygen atom attached thereto. The term “aralkoxy” as used herein means an aralkyl group, as defined above, having an oxygen atom attached thereto. Suitable aralkoxy groups have 1 to 3 separate or fused rings and from 6 to about 18 carbon ring atoms, e.g., O-benzyl.

The term “amino,” as used herein, refers to an unsubstituted or substituted moiety of the formula —NRₐR_{b}, in which Rₐ and R_{b} are each independently hydrogen, alkyl, aryl, or heterocyclyl, or Rₐ and R_{b}, taken together with the nitrogen atom to which they are attached, form a cyclic moiety having from 3 to 8 atoms in the ring. Thus, the term “amino” includes cyclic amino moieties such as piperidinyl or pyrrolidinyl groups, unless otherwise stated. An “amino-substituted amino group” refers to an amino group in which at least one of Rₐ and R_{b}, is further substituted with an amino group.

### SUMMARY OF THE INVENTION

Embodiments of the present invention are directed to a substrate for performing ionization desorption on porous silicon, methods for performing such ionization desorption and methods of making substrates. One embodiment directed to a substrate for performing ionization desorption on silicon comprises a substrate having a surface having a formula of:

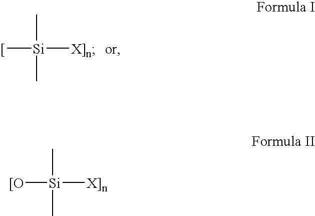

As used above, X is H or Y, where at least at least twenty five mole percent of X is Y and Y is hydroxyl, or —O—R₁ or O—SiR₁,R₂,R₃ wherein R₁,R₂, and R₃ are selected from the group consisting C₁ to C₆ straight, cyclic, or branched alkyl, aryl, or alkoxy group, a hydroxyl group, or a siloxane group, and R⁶ may be a C₁ to C₃₆ straight, cyclic, or branched alkyl (e.g., C₁₈, cyanopropyl), aryl, or alkoxy group, where the groups of R⁶ are unsubstituted or substituted with one or more moieties such as halogen, cyano, amino, diol, nitro, ether, carbonyl, epoxide, sulfonyl, cation exchanger, anion exchanger, carbamate, amide, urea, peptide, protein, carbohydrate, and nucleic acid functionalities. The letter “n” represents an integer from 1 to infinity and any vacant valences are silicon atoms, hydrogen or impurities.

Substrates having a surface as described above are resistant to further oxidation reactions. Thus, such substrates provide consistent results over time and repeated ionization events.

Preferably, the mole percent is twenty five to fifty, and more preferably forty to fifty.

In one preferred embodiment, Y is hydroxyl. In a further preferred embodiment, Y is hydroxyl and some portion of Y is represented by the Formula III below:

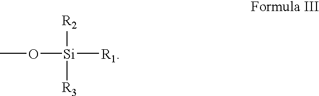

And, even more preferred, R₁,R₂, and R₃ are methyl or alkyl carbon chains of less than or equal to eighteen carbons. Where Y is represented by the Formula II, the mole percent of Formula II is preferably two to fifty. However, steric concerns generally limit the mole percent of Formula II compositions to six to ten.

A further embodiment of the present invention is directed to a method of making a substrate for performing ionization desorption on porous silicon. The method comprised the steps of providing a surface comprising silicon hydride on a porous silicon substrate. At least five mole percent of the silicon hydride is reacted with oxygen to form a silicon oxide.

Preferably, the oxygen is a reactive form such as ozone.

Preferably, the silicon oxide is reacted with a compound represented by the formula WY, wherein W is selected from the group consisting of halogens, methoxy, alkoxy or ethoxy, and Y is represented by Formula IV below:

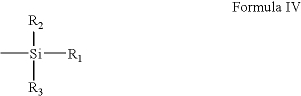

The letters R₁,R₂, and R₃ are used in the same sense as described above. One preferred compound represented by the formula WY is trimethylchlorosilane.

A further embodiments of the present invention is directed to a method of performing laser desorption ionization on porous silicon. The method comprises the steps of providing a sample on a porous silicon surface having a formula of: 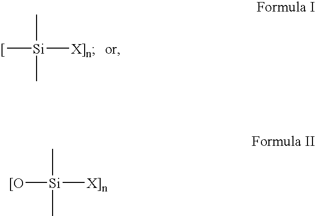
wherein X and the letter “n” are as described above.

Substrates having a surface as described above are resistant to further oxidation reactions. Thus, such substrates provide consistent results over time and repeated ionization events. The surfaces can also be derivatized to provide selectivity in adsorption. For example, where the modification of the surface has functions of cationic exchange, basic compounds within the sample applied to the surface may be selectively retained.

These advantages and features, as well as others, are further depicted in the drawings and detailed discussion which follow.

### BRIEF DESCRIPTION OF THE DRAWINGS

FIG. 1 depicts a substrate for performing desorption ionization on silicon having features of the present invention.

FIG. 2 depicts a mass spectrometer equipped with a laser for performing desorption ionization on a silicon substrate employing features of the present invention.

### DETAILED DESCRIPTION OF THE INVENTION

The present invention will be described in detail as a substrate for performing ionization desorption on porous silicon, methods for performing such ionization desorption and methods of making substrates. Embodiments of the present invention will be described with respect to a system in which sample is ionized and vaporized for use in a mass analyzer. However, those skilled in the art will readily recognize that the present invention has utility for all applications in which a sample is ionized and vaporized.

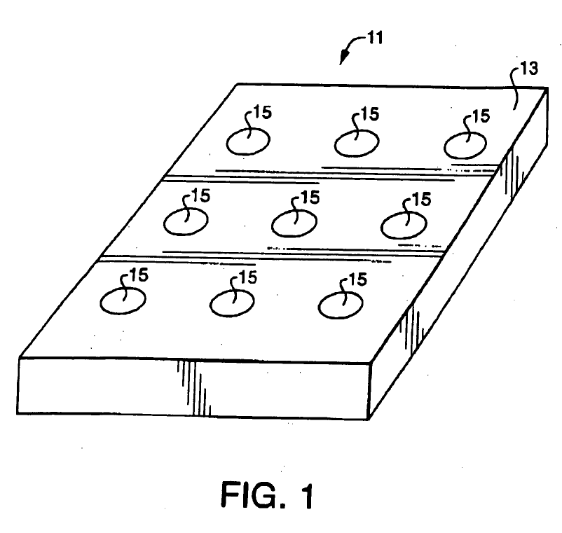

One embodiment directed to a substrate for performing ionization desorption on silicon. A substrate embodying features of the present invention, generally designated by the numeral 11, is depicted in FIG. 1. The substrate is typically rectangular or square in shape, having dimensions of approximately three to four centimeters in length, four to five centimeters in width and one half millimeter in depth. These dimensions and the shape of the substrate are not critical for the function of the substrate but reflect current manufacturing and application preferences. It is common to make such substrates 11 with dimensions to cooperate with holders and other laboratory devices, such as 96 well devices.

The substrate 11 has a surface 13 which extends around the article. However, the features of the present invention are most concerned with the working surface upon which ionization events will occur. Surface 13 has samples identified by the numeral 15 denoting the working surface of the substrate 11. Surface 13 is porous to facilitate retention of the sample 15. Methods of creating a porous silicon surface, are known in the art, for examples, as taught in U.S. Pat. No. 6,288,390. Such surfaces are normally created by laser etching a silicon surface.

Substrate 11 has an interior mass having a silicon composition. The surface 13 has a composition reflecting the termination of the silicon mass. The surface 13 has a composition represented by the formula:

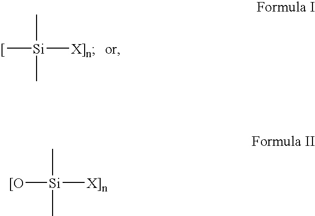

As used above, X is H or Y, where at least at least twenty five mole percent of X is Y and Y is hydroxyl, or —O—R₁, or —O—SiR₁,R₂,R₃ wherein R₁, R₂, and R₃ are selected from the group consisting C₁ to C₆ straight, cyclic, or branched alkyl, aryl, or alkoxy group, a hydroxyl group, or a siloxane group, and R⁶ may be a C₁ to C₃₆ straight, cyclic, or branched alkyl (e.g., C_{18,} cyanopropyl), aryl, or alkoxy group, where the groups of R⁶ are unsubstituted or substituted with one or more moieties such as halogen, cyano, amino, diol, nitro, ether, carbonyl, epoxide, sulfonyl, cation exchanger, anion exchanger, carbamate, amide, urea, peptide, protein, carbohydrate, and nucleic acid functionalities. The letter “n” represents an integer from 1 to infinity and any vacant valences are silicon atoms, hydrogen or impurities.

Substrates 11 having a surface 13 as described above are resistant to further oxidation reactions. Thus, such substrates 11 provide consistent results over time and repeated ionization events. For example, substrates for performing desorption ionization are routinely used repeatedly. Substrates with a hydride surface chemistry react in response to energy received in the ionization process, the sample, and the atmosphere. These changes in surface chemistry alter the manner in which a further sample will respond to further ionization events. The results from subsequent ionization events differ from early ionization events, which is undesirable.

For greater consistency in results, the mole percent is twenty five to fifty, and more preferably forty to fifty.

In one preferred embodiment, Y is hydroxyl. In a further preferred embodiment, at least a portion of Y is represented by the Formula III below:

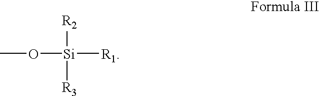

And, even more preferred, R₁, R₂, and R₃ are methyl or alkyl carbon chains of less than or equal to eighteen carbons. And, even more preferred, R₁, R₂, and R₃ are methyl. Due to steric hindrance the mole percent of Formula III compositions is preferably at least two, and more preferably, six to ten.

A further embodiment of the present invention is directed to a method of making a substrate for performing ionization desorption on porous silicon. The method comprised the steps of providing a surface comprising silicon hydride on a porous silicon substrate. At least five mole percent of the silicon hydride is reacted with oxygen to form a silicon oxide.

Preferably, the oxygen in a reactive form such as ozone. Methods for reacting silicon surfaces with ozone are known in the art. The silicon surfaces are exposed to an atmosphere of concentrated ozone and allowed to react to form a silicon oxide.

Preferably, the silicon oxide is reacted with a compound represented by the formula WY, wherein W is selected from the group consisting of halogens, methoxy, alkoxy or ethoxy, and Y is represented by Formula IV below:

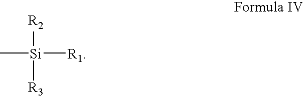

The letters R₁,R₂, and R₃ are used in the same sense as described above. The compound represented by WY, may comprise any organosilane. One preferred compound represented by the formula WY is trimethylchlorosilane. A further preferred compound is aminopropyldimethylethoxysilane.

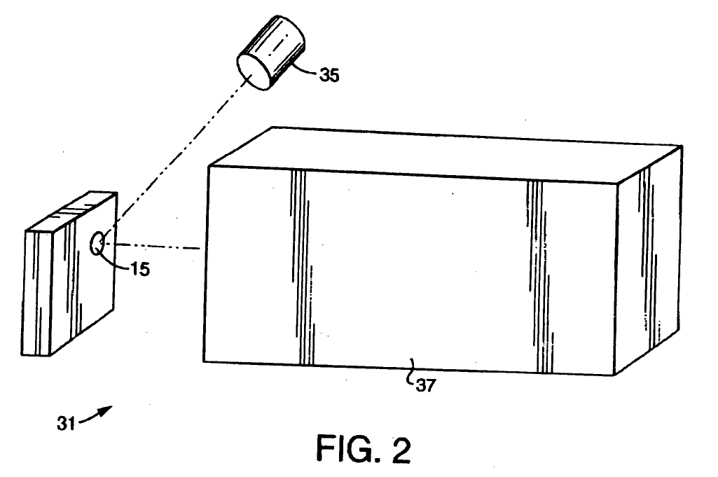

A further embodiments of the present invention is directed to a method of performing laser desorption ionization on porous silicon. The method will be described with respect to the apparatus depicted in FIG. 2. An apparatus for performing laser desorption ionization on porous silicon, generally designated by the numeral 31, has the following major elements: a porous substrate 11, a laser 35, and a mass spectrometer 37.

Porous substrate 11 is held in alignment with laser 35 by means of a holder (not shown) of standard known configuration. The porous substrate 11 is positioned in close proximity to the inlet (not shown) of mass spectrometer 37.

Mass spectrometer 37 of the commonly of the time of flight type, of known configuration. And, therefore, mass spectrometer 37 is not depicted in detail.

A sample 15 is placed on the porous silicon surface 13 of substrate 11. The porous silicon surface 13 has a surface chemistry having a formula of: 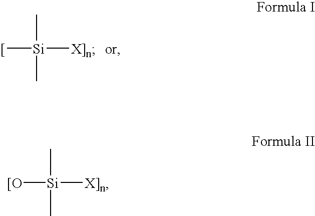
wherein X and the letter “n” are as described above.

Laser 35 is discharged or pulsed ionizing and vaporizing a portion of the sample 15. Vapor, ions and gases are drawn into the inlet of the mass spectrometer 37 for analysis. Mass spectrometer 37 provides mass and charge information, such as the mass to charge ratio, as to ions received.

Substrates 11 having a surface 13 as described above are resistant to further oxidation reactions. Thus, such substrates provide consistent results over time and repeated ionization events.

### Example 1

The silicon oxide surface of a substrate was reacted with trimethylchlorosilane, and then washed with neat isopropanol. A sample of bovine serum albumin (BSA) digest was applied to the surface and analyzed using a matrix assisted laser desorption ionization mass spectrometer (MALDI-MS) instrument. 500 amol could be detected, at a concentration comparable to that detected by DIOS-MS from a silicon hydride surface. DIOS-MS was performed on the trimethylsilane (TMS)-derivatized surface over the course of several weeks, and no reduction in signal intensity was observed over that time. In contrast, an underivatized DIOS surface shows significant signal deterioration after 2-3 weeks.

### Example 2

The silicon oxide surface was reacted with aminiopropyldimethylethoxysilane. This derivatized surface has been found to provide an enhancement in selectivity for certain compounds. For example, sugars such as sucrose and maltotriose cannot be readily detected by DIOS using silicon hydride surfaces, or TMS-derivatized surfaces. However, the amine-derivatized surface provides several orders of magnitude enhancement in signal. This derivatized surface provides selectivity in adsorption. For example, derivatizing a surface with a cation exchanger would selectively bind basic compounds, and would enable easy removal of neutrals and acid interferences. One example demonstrated with TMS-derivatized surfaces is that peptide digests in a solution of 8M urea can be loaded onto a chip, and the peptide will strongly adsorb to the surface. The non-binding urea can then be easily removed prior to mass spec analysis. A fourth benefit of this derivatization technique is that it provides for a simple means to alter the physical properties of the surface. For example, an amine-derivatized surface will provide a much higher surface tension (contact angle is solvent dependent) than silicon hydride or TMS derivatized surface. By patterning the surface with one or more silane reactants, the surface hydrophobicity can be selectively altered to help position and/or concentrate a sample of the surface.

These and other advantages will be apparent to those skilled in the art. Therefore, the present invention should not be limited to the details described in the description but should encompass such subject matter as defined in the claims.

What is claimed:

1. A substrate for performing ionization desorption on silicon comprising a substrate having a formula of: 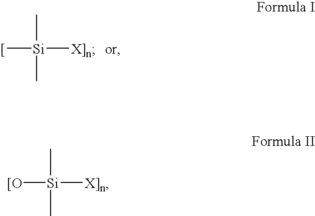
wherein X is H or Y, where at least at least twenty five mole percent of X is Y and Y is hydroxyl, or —O—R₁, or —O—SiR₁, R₂,R₃ wherein R₁,R₂, and R₃ are selected from the group consisting C₁ to C₆ straight, cyclic, or branched alkyl, aryl, or alkoxy group, a hydroxyl group, or a siloxane group, and R⁶ may be a C₁ to C₃₆ straight, cyclic, or branched alkyl (e.g., C_{18,}cyanopropyl), aryl, or alkoxy group, where the groups of R⁶ are unsubstituted or substituted with one or more moieties such as halogen, cyano, amino, diol, nitro, ether, carbonyl, epoxide, sulfonyl, cation exchanger, anion exchanger, carbamate, amide, urea, peptide, protein, carbohydrate, and nucleic acid functionalities, and the letter “n” represents an integer from 1 to infinity and any vacant valences are silicon atoms, hydrogen or impurities.

2. The article of manufacture of claim 1 wherein Y is hydroxyl.

3. The article of manufacture of claim 1 wherein said mole percent is twenty-five to fifty.

4. The article of manufacture of claim 1 wherein at least a portion of Y is represented by the Formula III below:

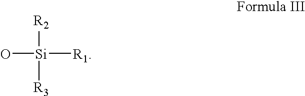

5. The article of manufacture of claim 4 wherein R₁,R₂, and R₃ are methyl or alkyl carbon chains of less than or equal to eighteen carbons.

6. A method of making a substrate for performing ionization desorption on silicon, comprising the steps of providing a surface comprising silicon hydride on said substrate, reacting at least five mole percent of the silicon hydride with oxygen to form a silicon oxide.

7. The method of claim 6 further comprising reacting said silicon oxide with a compound represented by the formula WY, wherein W is selected from the group consisting of halogens, methoxy, alkoxy or ethoxy, and Y is represented by formula: 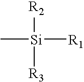
wherein R₁, R₂, and R₃ are selected from the group consisting C₁ to C₆ straight, cyclic, or branched alkyl, aryl, or alkoxy group, a hydroxyl group, or a siloxane group, and R⁶ may be a C₁ to C₃₆ straight, cyclic, or branched alkyl (e.g., C_{18,} cyanopropyl), aryl, or alkoxy group, where the groups of R⁶ are unsubstituted or substituted with one or more moieties such as halogen, cyano, amino, diol, nitro, ether, carbonyl, epoxide, sulfonyl, cation exchanger, anion exchanger, carbamate, amide, urea, peptide, protein, carbohydrate, and nucleic acid functionalities.

8. The method of claim 7 wherein said compound represented by the formula WY is trimethylchlorosilane.

9. The method of claim 7 wherein said compound represented by the formula WY is amino propyldimethylethoxysilane.

10. A method of performing performing laser desorption ionization on silicon comprising the steps of providing a sample on a porous silicon surface having a formula of: 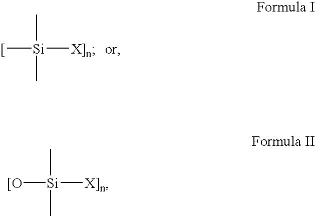
wherein X is H or Y, where at least at least twenty five mole percent of X is Y and Y is hydroxyl, or —O—R₁, or —O—SiR₁,R₂,R₃ wherein R₁, R₂, and R₃ are selected from the group consisting C₁ to C₆ straight, cyclic, or branched alkyl, aryl, or alkoxy group, a hydroxyl group, or a siloxane group, and R⁶ may be a C₁ to C₃₆ straight, cyclic, or branched alkyl (e.g., C_{18,} cyanopropyl), aryl, or alkoxy group, where the groups of R⁶ are unsubstituted or substituted with one or more moieties such as halogen, cyano, amino, diol, nitro, ether, carbonyl, epoxide, sulfonyl, cation exchanger, anion exchanger, carbamate, amide, urea, peptide, protein, carbohydrate, and nucleic acid functionalities, ionizing at least a portion of said sample by means of a laser to form an ionized sample, placing said ionized sample in mass spectrometer means for a determination of a mass charge relationship.

11. The article of manufacture of claim 10 wherein Y is hydroxyl.

12. The article of manufacture of claim 10 wherein said mole percent is twenty five to fifty.

13. The article of manufacture of claim 10 wherein at least a portion of Y is represented by the Formula III below:

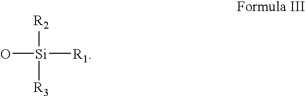

14. The article of manufacture of claim 13 wherein R₁, R₂, and R₃ are methyl or alkyl carbon chains of less than or equal to eighteen carbons.

15. An apparatus for performing laser desorption ionization mass analysis comprising:
a substrate having a porous silicon surface having a formula of: 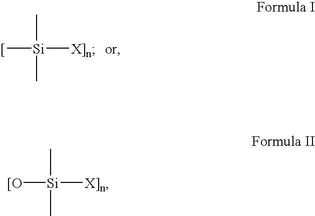
wherein X is H or Y, where at least at least twenty five mole percent of X is Y and Y is hydroxyl, or —O—R₁, or —O—SiR₁,R₂,R₃ wherein R₁, R₂, and R₃ are selected from the group consisting C₁ to C₆ straight, cyclic, or branched alkyl, aryl, or alkoxy group, a hydroxyl group, or a siloxane group, and R⁶ may be a C₁ to C₃₆ straight, cyclic, or branched alkyl (e.g., C_{18,} cyanopropyl), aryl, or alkoxy group, where the groups of R⁶ are unsubstituted or substituted with one or more moieties such as halogen, cyano, amino, diol, nitro, ether, carbonyl, epoxide, sulfonyl, cation exchanger, anion exchanger, carbamate, amide, urea, peptide, protein, carbohydrate, and nucleic acid functionalities, and the letter “n” represents an integer from 1 to infinity and any vacant valences are silicon atoms, hydrogen or impurities;
a laser aligned with said substrate to pulse light energy on said sample to ionize and vaporize a portion of said sample, to form a ionized sample, and
a mass analyser for receiving said ionized sample for a determination of a mass charge relationship.

16. The apparatus of claim 14 wherein said Y is represented by the Formula III below: 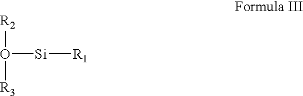
and, Y represented by Formula III has a mole percent of two to ten.
